(19) United States
(12) Patent Application Publication
(10) Pub. No.: US 2016/0066612 A1
(43) Pub. Date: Mar. 10, 2016

(54) THREE-DIMENSIONAL FORMING APPARATUS AND METHOD FOR MANUFACTURING MEAT SUBSTITUTE

(71) Applicant: MICROJET TECHNOLOGY CO., LTD., Hsinchu (TW)

(72) Inventors: Hao-Jan Mou, Hsinchu (TW); Ta-Wei Hsueh, Hsinchu (TW); Yung-Lung Han, Hsinchu (TW); Chi-Feng Huang, Hsinchu (TW)

(21) Appl. No.: 14/809,969

(22) Filed: Jul. 27, 2015

(30) Foreign Application Priority Data
Sep. 4, 2014 (TW) 103130551
Sep. 4, 2014 (TW) 103130569

(51) Int. Cl. A23L 1/314

(52) U.S. Cl. CPC A23L 1/314; A23L 1/31418

(57) ABSTRACT

A three-dimensional meat substitute forming apparatus includes a control computer for previously storing an image file of a meat model and outputting a control command corresponding to the image file of the meat model. The powdery meat substitute material is a powdery non-meat protein food material. A three-dimensional meat substitute forming method includes a pretreating process, a soaking and grinding process, a slurry boiling and filtering process, an atomization drying process, a powder spreading and stratifying process, a printing and solidifying process, a laminating process and an excess powder removing process. Consequently, a three-dimensional meat substitute is produced.

### FIELD OF THE INVENTION

The present invention relates to an apparatus and a method for manufacturing a meat substitute, and more particularly to a three-dimensional forming apparatus and a three-dimensional forming method for manufacturing a meat substitute.

### BACKGROUND OF THE INVENTION

In recent years, food industries have spent a lot of money and effort in producing non-meat protein products such as vegetable protein products (hereinafter referred as meat substitute, vegetarian chicken or vegetarian meat). For example, soybean or soybean protein can be processed into meat substitute in replace of animal meat. If the meat substitute is produced in a cost-effective manner, the meat substitute can gradually replace the animal meat in order to overcome the shortage of animal meat.

In accordance with a conventional method, the non-meat protein material is thermally pressed into the meat substitute. However, the appearance of the meat substitute is far from the appearance of the animal meat. In addition, the quality of the meat substitute is unstable, and the meat substitute is not aesthetically pleasing. Since the meat substitute produced by the conventional method is not satisfied to many users, the purpose of replacing the animal meat is still unattainable. In other words, the method of producing the meat substitute needs to be further improved.

### SUMMARY OF THE INVENTION

An object of the present invention provides a three-dimensional forming apparatus and a three-dimensional forming method for manufacturing a meat substitute. The powdery meat substitute material such as a powdery non-meat protein food material is used as the raw material in replace of the animal meat material. After the three-dimensional forming method is performed by the three-dimensional forming apparatus, a three-dimensional meat substitute is produced. The meat substitute has more pleasing and fantastic appearance than the animal meat. The three-dimensional meat substitute has appearance of a dried tofu, a bean curd, a tofu, gluten, a fried tofu, a hot dog, a frankfurter, a meatball, a Chinese sausage, a sausage, any other particulate sausage, a meat velvet, meat crisp, a fried meat crisp, a beef jerky, a meat chunk, a meat strip, a meat shred, any other dried meat product, a preserved ham, a salted duck, a pickled meat, a whole body of a chicken, a duck, a goose, a cow, a pig or a sheep, the rib of a chicken, a duck, a goose, a cow, a pig or a sheep, or a leg, a wing, a foot or a segment of a chicken, a duck, a goose, a cow, a pig or a sheep. The above three-dimensional meat substitutes are cooked by a barbecuing means or a stewing means. Alternatively, the three-dimensional meat substitute has appearance of a whole body or an inside egg of freshwater fish or saltwater fish.

In accordance with an aspect of the present invention, there is provided a three-dimensional meat substitute forming apparatus for laminating a powdery meat substitute material as a three-dimensional meat substitute. The three-dimensional meat substitute forming apparatus includes a control computer for previously storing an image file of a meat model and outputting a control command corresponding to the image file of the meat model. The powdery meat substitute material is a powdery non-meat protein food material.

In accordance with another aspect of the present invention, there is provided a three-dimensional meat substitute forming method. The three-dimensional meat substitute forming method includes a pretreating process, a soaking and grinding process, a slurry boiling and filtering process, an atomization drying process, a powder spreading and stratifying process, a printing and solidifying process, a laminating process and an excess powder removing process. Consequently, a three-dimensional meat substitute is produced.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a flowchart illustrating a three-dimensional forming method for manufacturing a meat substitute according to an embodiment of the present invention; and

FIG. 2 is a schematic perspective view illustrating a three-dimensional forming apparatus according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

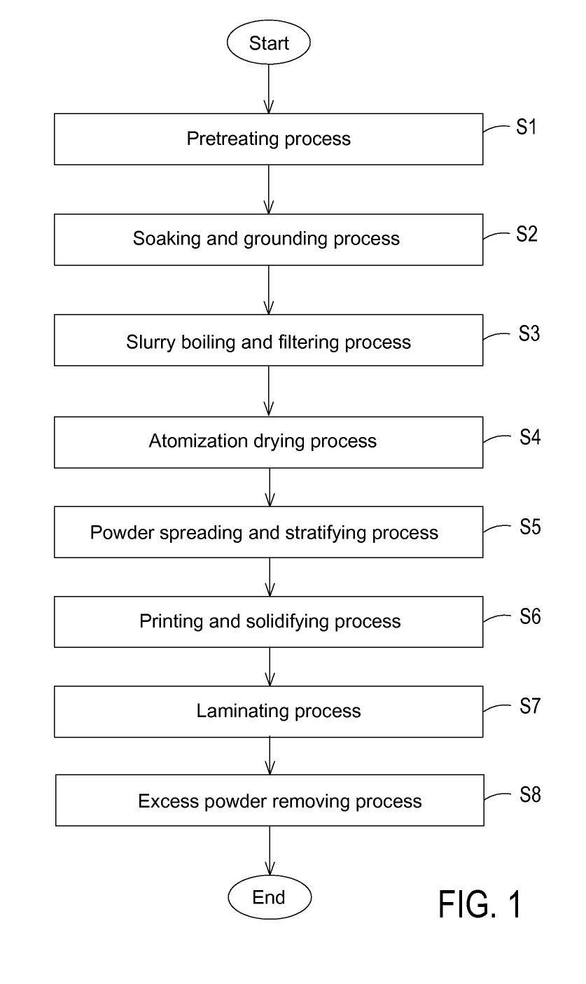

The present invention provides a three-dimensional forming apparatus and a three-dimensional forming method for manufacturing a meat substitute. FIG. 1 is a flowchart illustrating a three-dimensional forming method for manufacturing a meat substitute according to an embodiment of the present invention. The three-dimensional forming method comprises the following steps.

Firstly, a pretreating process is performed to pretreat a powdery meat substitute material such as non-meat protein food material (Step S1). The powdery meat substitute material is a soybean-based material. A plurality of high-quality soybeans with uniform particle diameter and high protein content (e.g., protein content 40%) and without moth holes and fever mildew are taken. After the impurities are carefully removed, the soybeans are repeatedly washed by drink water. The soils and foreign matters adsorbed on the surfaces of the soybeans are thoroughly removed, so that the quality is not adversely affected.

Secondly, a soaking and grinding process is performed (Step S2). During the soaking and grinding process, the time duration, temperature and water for soaking the soybeans should be precisely controlled. In particular, the soybeans are placed in water at the temperature in the range between 14° C. and 25° C., wherein the ratio of soybean to water is 1:1.50. After the soybeans are soaked in the water for 8˜10 hours, the soybeans are washed with 10 times of odorless water. Then, the soybeans are ground by a grinder at room temperature. Consequently, soybean mud (particle fineness>80 meshes) is formed.

Thirdly, a slurry boiling and filtering process is performed (Step S3). After the soybean mud is boiled at 100° C. for 45 to 60 minutes, the soybean mud is dried at 105° C. for 10 minutes. Consequently, a high-temperature soybean slurry is formed. After the soybean slurry is boiled and filtered with a drum sieve or a vibration sieve to filter off the soybean mud, the residual protein content in the bean dreg is as low as possible. In the grinding step, the boiling step and the filtering step, the pH of the soybean slurry should be properly controlled and regulated. Consequently, the soybean protein extract percentage is increased. Preferably, the pH of the soybean slurry is adjusted to 6.50.

Fourthly, an atomization drying process is performed (Step S4). After the soybean slurry is filtered and regulated to emulsion, the soybean slurry is dried as soybean powder by the atomization drying process. In an embodiment, the soybean slurry is placed within a nozzle atomizer, ejected as liquid droplets through the nozzles, and sprayed as atomized droplets into a hot air dryer. After the atomized droplets are dried by the hot air in the hot air dryer, the soybean slurry is dried as the soybean powder with fine particles.

Fifthly, a powder spreading and stratifying process is performed (Step S5). The soybean powder is provided to the three-dimensional forming apparatus (i.e., a food ingredient laminating device) and spread to a construction chamber. Consequently, a stratified powder profile matching a cross section of a meat model is produced.

Sixthly, a printing and solidifying process is performed (Step S6). A printing mechanism of the three-dimensional forming apparatus (i.e., a food ingredient laminating device) prints a fluidic binder on a part of the stratified powder profile. After the fluidic binder and the stratified powder layer stick together and become solidified, a single layer structure is produced. In an embodiment, the fluidic binder is a fluidic binder additive composed of cellulose, vitamin, dietary mineral, protein and flavoring. For example, the fluidic binder is printed on an inner periphery of the stratified powder profile. In another embodiment, the fluidic binder is a fluidic food coloring agent. For example, the fluidic binder is printed on an outer periphery of the stratified powder profile.

Seventhly, a laminating process is performed (Step S7). That is, the powder spreading and stratifying process (Step S6) and the printing and solidifying process (Step S7) are repeatedly done. Consequently, a three-dimensional meat substitute (not shown) is formed in the construction chamber by stacking multiple single layer structures.

Eighthly, an excess powder removing process is performed to remove the excess soybean powder, and the three-dimensional meat substitute is taken out from the construction chamber (Step S8).

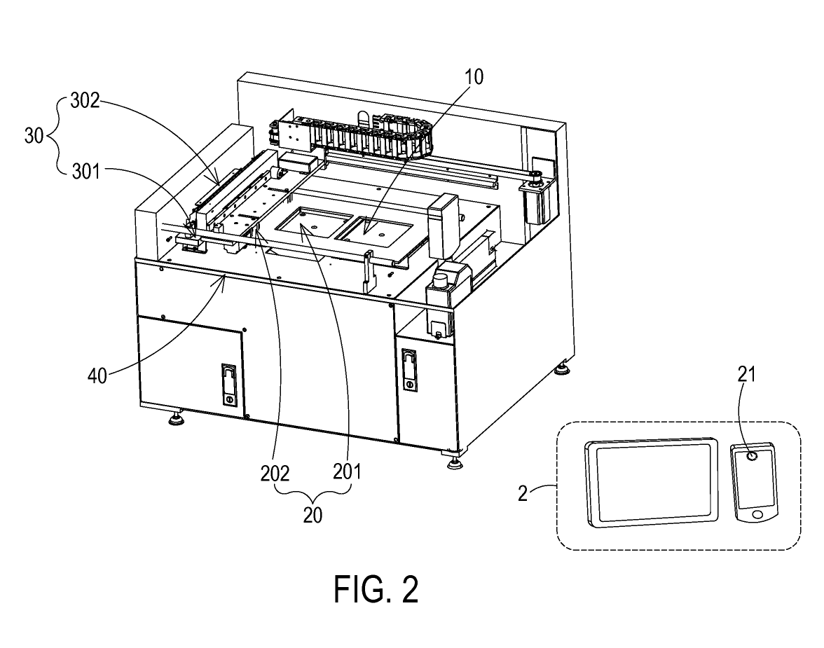

FIG. 2 is a schematic perspective view illustrating a three-dimensional forming apparatus according to an embodiment of the present invention. The three-dimensional forming apparatus comprises a control computer 2 (not shown), a construction chamber 10, a powder spreading mechanism 20 and a printing mechanism 30.

The control computer 2 is used for previously storing an image file of a desired meat model and outputting a control command corresponding to the image file of the meat model. For example, the control computer 2 is a tablet computer, a mobile phone, a smart phone, a wearable device or any other comparable device. Moreover, the control computer 2 further comprises a three-dimensional scanner 21 for scanning a three-dimensional meat substitute and obtaining an image file of the three-dimensional meat substitute, so that the image file is previously stored.

In this embodiment, the powder spreading mechanism 20 comprises a powder feeder 201 and a powder spreader 202. The powder feeder 201 is used for containing the soybean powder and allowing the soybean powder therein to be moved upwardly or downwardly. The powder spreader 202 is located over the printing mechanism 30 and moved with the printing mechanism 30. As the soybean powder in the powder feeder 201 is moved upwardly, the topmost layer of the soybean powder is pushed to the construction chamber 10 by the powder spreader 202.

According to the control command from the control computer 2, the printing mechanism 30 ejects the fluidic binder to the soybean powder within the construction chamber 10. After the fluidic binder and the stratified powder layer stick together and become solidified, a single layer structure of the three-dimensional meat substitute is produced.

The printing mechanism 30 comprises a movable carrying mechanism 301 and at least one printhead 302. The movable carrying mechanism 301 is disposed on a working platform 40. Moreover, the at least one nozzle 302 and the powder spreader 202 of the powder spreading mechanism 20 are supported on the movable carrying mechanism 301 and moved with the movable carrying mechanism 301. According to the control command from the control computer 2, the movable carrying mechanism 301 is moved across the construction chamber 10 in bidirectional reciprocation. Each of the at least one printhead 302 comprises a fluidic binder supply tank (not shown) and plural nozzles (not shown). The fluidic binder supply tank contains the fluidic binder. The nozzles are in communication with the fluidic binder supply tank. According to the control command from the control computer 2, the nozzles eject the fluidic binder.

After the above three-dimensional forming method is performed by the three-dimensional forming apparatus, a three-dimensional meat substitute is produced. The meat substitute has more pleasing and fantastic appearance than the animal meat.

Hereinafter, a three-dimensional forming method performed by the three-dimensional forming apparatus will be illustrated in more details as follows.

Firstly, a powder spreading and stratifying process is performed. That is, the meat substitute powder is provided to the powder feeder 201 of the powder spreading mechanism 20. For example, the meat substitute powder includes but is not limited to green bean powder, red bean powder, black bean powder, pea powder, broad bean powder, garbanzo powder, peanut powder, soya bean powder, haricot bean powder, white bean powder, pinto bean powder, kidney bean powder, chickpea powder, green soya bean powder, Brazil bean powder, natto powder, lima bean powder, snap bean powder, sword bean powder or lentil powder. As the meat substitute powder in the powder feeder 201 is moved upwardly, the topmost layer of meat substitute powder is pushed to the construction chamber 10 by the powder spreader 202. Consequently, a stratified powder profile matching a cross section of a meat model is produced. Then, a printing and solidifying process is performed. According to the control command from the control computer 2, the movable carrying mechanism 301 is moved in the direction toward the construction chamber 10. Consequently, the at least one printhead 302 on the movable carrying mechanism 301 ejects the fluidic binder to the stratified powder profile within the construction chamber 10. After the fluidic binder and the stratified powder layer stick together and become solidified, a single layer structure is produced. In an embodiment, the fluidic binder is a fluidic binder additive composed of cellulose, vitamin, dietary mineral, protein and flavoring. An example of the flavoring includes but is not limited to soy sauce, saline water, vinegar, edible alcohol, syrup, chili oil, edible oil, sesame oil, cinnamon oil, nutmeg oil, celery oil, coriander oil, black pepper oil, fish sauce, tomato sauce, bitten, oyster sauce, XO sauce or juice. For example, the fluidic binder is printed on the inner periphery of the stratified powder profile. In another embodiment, the fluidic binder is a fluidic food coloring agent printed on the outer periphery of the stratified powder profile, so that the product is colored.

Then, a laminating process is performed. That is, the powder spreading and stratifying process and the printing and solidifying process are repeatedly done. In other words, after the fluidic binder and the stratified powder layer stick together and become solidified, a single layer structure is produced. Then, the meat substitute powder is spread to the single layer structure. Consequently, an additional stratified powder profile matching another cross section of the meat model is produced. Then, the at least one printhead 302 ejects the fluidic binder to the additional stratified powder profile. After the fluidic binder and the additional stratified powder layer stick together and become solidified, an additional single layer structure is produced. The above steps are repeatedly done. Consequently, multiple single layer structures are stacked on each other in the construction chamber 10.

Afterwards, the excess meat substitute powder is removed, and the three-dimensional meat substitute is taken out from the construction chamber 10. Preferably, the three-dimensional meat substitute has appearance of a dried tofu, a bean curd, a tofu, gluten, a fried tofu, a hot dog, a frankfurter, a meatball, a Chinese sausage, a sausage, any other particulate sausage, a meat velvet, meat crisp, a fried meat crisp, a beef jerky, a meat chunk, a meat strip, a meat shred, any other dried meat product, a preserved ham, a salted duck, a pickled meat, a whole body of a chicken, a duck, a goose, a cow, a pig or a sheep, the rib of a chicken, a duck, a goose, a cow, a pig or a sheep, or a leg, a wing, a foot or a segment of a chicken, a duck, a goose, a cow, a pig or a sheep. The above three-dimensional meat substitutes are cooked by a barbecuing means or a stewing means. Alternatively, the three-dimensional meat substitute has appearance of a whole body or an inside egg of freshwater fish or saltwater fish.

From the above descriptions, the present invention provides a three-dimensional forming apparatus and a three-dimensional forming method for manufacturing a meat substitute. The powdery meat substitute material such as a powdery non-meat protein food material is used as the raw material in replace of the animal meat material. After the three-dimensional forming method is performed by the three-dimensional forming apparatus, a three-dimensional meat substitute is produced. The meat substitute has more pleasing and fantastic appearance than the animal meat. Since the three-dimensional meat substitute is delicious and has nutrient comparable to the animal meat, the three-dimensional forming apparatus and the three-dimensional forming method of present invention are industrially applicable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A three-dimensional meat substitute forming apparatus for laminating a powdery meat substitute material as a three-dimensional meat substitute, the three-dimensional meat substitute forming apparatus comprising a control computer for previously storing an image file of a meat model and outputting a control command corresponding to the image file of the meat model, wherein the powdery meat substitute material is a powdery non-meat protein food material.

2. The three-dimensional meat substitute forming apparatus according to claim 1, wherein the control computer is a tablet computer, a mobile phone, a smart phone, a wearable device or any other comparable device.

3. The three-dimensional meat substitute forming apparatus according to claim 1, wherein the control computer further comprises a three-dimensional scanner for scanning the image file of the meat model, so that the image file is previously stored.

4. The three-dimensional meat substitute forming apparatus according to claim 1, wherein the powdery meat substitute material is soybean powder.

5. The three-dimensional meat substitute forming apparatus according to claim 1, wherein the powdery meat substitute material is selected from at least one of green bean powder, red bean powder, black bean powder, pea powder, broad bean powder, garbanzo powder, peanut powder, soya bean powder, haricot bean powder, white bean powder, pinto bean powder, kidney bean powder, chickpea powder, green soya bean powder, Brazil bean powder, natto powder, lima bean powder, snap bean powder, sword bean powder and lentil powder.

6. The three-dimensional meat substitute forming apparatus according to claim 1, further comprising a powder spreading mechanism, wherein the powder spreading mechanism comprises a powder feeder for containing the powdery meat substitute material, and the powdery meat substitute material in the powder feeder is movable upwardly or downwardly.

7. The three-dimensional meat substitute forming apparatus according to claim 6, wherein the powder spreading mechanism further comprises a powder spreader, and the powder spreader is movable with the printing mechanism, wherein while the powdery meat substitute material in the powder feeder is moved upwardly, the topmost powdery meat substitute material is pushed to the construction chamber by the powder spreader, so that a stratified powder profile matching a cross section of the meat model is produced.

8. The three-dimensional meat substitute forming apparatus according to claim 7, wherein the printing mechanism comprises a movable carrying mechanism and at least one printhead, wherein the movable carrying mechanism is disposed on a working platform of the three-dimensional meat substitute forming apparatus, and the at least one printhead and the powder spreader of the powder spreading mechanism are moved with the movable carrying mechanism, wherein according to the control command from the control computer, the movable carrying mechanism is moved across the construction chamber in bidirectional reciprocation.

9. The three-dimensional meat substitute forming apparatus according to claim 8, wherein the printhead comprises a fluidic binder supply tank and plural nozzles, wherein the fluidic binder supply tank contains a fluidic binder, and nozzles are in communication with the fluidic binder supply tank, wherein according to the control command from the control computer, the nozzles eject the fluidic binder on the stratified powder profile, wherein after the fluidic binder and the stratified powder layer stick together and become solidified, a single layer structure is produced.

10. The three-dimensional meat substitute forming apparatus according to claim 9, wherein the fluidic binder is a fluidic binder additive composed of cellulose, vitamin, dietary mineral and/or protein, wherein the fluidic binder is printed on an inner periphery of the stratified powder profile.

11. The three-dimensional meat substitute forming apparatus according to claim 9, wherein the fluidic binder contains a fluidic flavoring selected from at least one of soy sauce, saline water, vinegar, edible alcohol, syrup, chili oil, edible oil, sesame oil, cinnamon oil, nutmeg oil, celery oil, coriander oil, black pepper oil, fish sauce, tomato sauce, bitten, oyster sauce, XO sauce and juice, wherein the fluidic binder is printed on an inner periphery of the stratified powder profile.

12. The three-dimensional meat substitute forming apparatus according to claim 9, wherein the fluidic binder is a fluidic food coloring agent printed on an outer periphery of the stratified powder profile.

13. The three-dimensional meat substitute forming apparatus according to claim 1, wherein the three-dimensional meat substitute has appearance of a dried tofu, a bean curd, a tofu, gluten or a fried tofu.

14. The three-dimensional meat substitute forming apparatus according to claim 1, wherein the three-dimensional meat substitute has appearance of a hot dog, a frankfurter, a meatball, a Chinese sausage, a sausage or a particulate sausage.

15. The three-dimensional meat substitute forming apparatus according to claim 1, wherein the three-dimensional meat substitute has appearance of a meat velvet, meat crisp, a fried meat crisp, a beef jerky, a meat chunk, a meat strip, a meat shred or a dried meat product.

16. The three-dimensional meat substitute forming apparatus according to claim 1, wherein the three-dimensional meat substitute has appearance of a preserved ham, a salted duck or a pickled meat.

17. The three-dimensional meat substitute forming apparatus according to claim 1, wherein the three-dimensional meat substitute has appearance of a whole body of a chicken, a duck, a goose, a cow, a pig or a sheep, rib of a chicken, a duck, a goose, a cow, a pig or a sheep, or a leg, a wing, a foot or a segment of a chicken, a duck, a goose, a cow, a pig or a sheep, and the three-dimensional meat substitute is cooked by a barbecuing means.

18. The three-dimensional meat substitute forming apparatus according to claim 1, wherein the three-dimensional meat substitute has appearance of a whole body of a chicken, a duck, a goose, a cow, a pig or a sheep, rib of a chicken, a duck, a goose, a cow, a pig or a sheep, or a leg, a wing, a foot or a segment of a chicken, a duck, a goose, a cow, a pig or a sheep, and the three-dimensional meat substitute is cooked by a stewing means.

19. The three-dimensional meat substitute forming apparatus according to claim 1, wherein the three-dimensional meat substitute has appearance of a whole body or an inside egg of freshwater fish or saltwater fish.

20. A three-dimensional meat substitute forming method, comprising steps of:
performing a pretreating process to pretreat a meat substitute material, wherein the meat substitute material is a non-meat protein food material;
performing a soaking and grinding process;
performing a slurry boiling and filtering process;
performing an atomization drying process;
performing a powder spreading and stratifying process;
performing a printing and solidifying process;
performing a laminating process; and
performing an excess powder removing process, and producing a three-dimensional meat substitute.

21. The three-dimensional meat substitute forming method according to claim 20, wherein in the soaking and grinding process, the meat substitute material is soaked in water for a certain time period and ground into a mud of the meat substitute material.

22. The three-dimensional meat substitute forming method according to claim 21, wherein in the slurry boiling and filtering process, the mud of the meat substitute material is boiled to a slurry of the meat substitute material and then filtered, so that a residual protein content in a dreg of the meat substitute material is reduced and a protein extract percentage is increased.

23. The three-dimensional meat substitute forming method according to claim 22, wherein in an atomization drying process, the slurry of the meat substitute material is filtered and regulated to emulsion, and the slurry of the meat substitute material is sprayed as atomized droplets into a hot air dryer by a nozzle atomizer, wherein the atomized droplets are dried by hot air in the hot air dryer, so that a powdery meat substitute material is formed.

24. The three-dimensional meat substitute forming method according to claim 23, wherein in the powder spreading and stratifying process, the powdery meat substitute material is provided to a three-dimensional meat substitute forming apparatus and spread to a construction chamber of the three-dimensional meat substitute forming apparatus, so that a stratified powder profile matching a cross section of the meat model is produced.

25. The three-dimensional meat substitute forming method according to claim 24, wherein in the printing and solidifying process, a printing mechanism of the three-dimensional meat substitute forming apparatus prints a fluidic binder on a part of the stratified powder profile, wherein after the fluidic binder and the stratified powder layer stick together and become solidified, a single layer structure is produced.

26. The three-dimensional meat substitute forming method according to claim 25, wherein in the laminating process, the powder spreading and stratifying process and the printing and solidifying process are repeatedly done, so that multiple single layer structures are stacked on each other in the construction chamber.

27. The three-dimensional meat substitute forming method according to claim 26, wherein after the multiple single layer structures are stacked on each other in the construction chamber, the excess powder removing process is performed to remove excess powdery meat substitute material, so that the three-dimensional meat substitute is produced.

28. The three-dimensional meat substitute forming method according to claim 20, wherein the meat substitute material is soybean.

29. The three-dimensional meat substitute forming method according to claim 20, wherein the meat substitute material is selected from at least one of green bean, red bean, black bean, pea, broad bean, garbanzo, peanut, soya bean, haricot bean, white bean, pinto bean, kidney bean, chickpea, green soya bean, Brazil bean, natto, lima bean, snap bean, sword bean and lentil.

30. The three-dimensional meat substitute forming method according to claim 25, wherein the fluidic binder is a fluidic binder additive composed of cellulose, vitamin, dietary mineral and/or protein, wherein the fluidic binder is printed on an inner periphery of the stratified powder profile.

31. The three-dimensional meat substitute forming method according to claim 25, wherein the fluidic binder contains a fluidic flavoring selected from at least one of soy sauce, saline water, vinegar, edible alcohol, syrup, chili oil, edible oil, sesame oil, cinnamon oil, nutmeg oil, celery oil, coriander oil, black pepper oil, fish sauce, tomato sauce, bitten, oyster sauce, XO sauce and juice, wherein the fluidic binder is printed on an inner periphery of the stratified powder profile.

32. The three-dimensional meat substitute forming method according to claim 25, wherein the fluidic binder is a fluidic food coloring agent printed on an outer periphery of the stratified powder profile.

33. The three-dimensional meat substitute forming method according to claim 20, wherein the three-dimensional meat substitute has appearance of a dried tofu, a bean curd, a tofu, gluten or a fried tofu.

34. The three-dimensional meat substitute forming method according to claim 20, wherein the three-dimensional meat substitute has appearance of a hot dog, a frankfurter, a meatball, a Chinese sausage, a sausage or a particulate sausage.

35. The three-dimensional meat substitute forming method according to claim 20, wherein the three-dimensional meat substitute has appearance of a meat velvet, meat crisp, a fried meat crisp, a beef jerky, a meat chunk, a meat strip, a meat shred or a dried meat product.

36. The three-dimensional meat substitute forming method according to claim 20, wherein the three-dimensional meat substitute has appearance of a preserved ham, a salted duck or a pickled meat.

37. The three-dimensional meat substitute forming method according to claim 20, wherein the three-dimensional meat substitute has appearance of a whole body of a chicken, a duck, a goose, a cow, a pig or a sheep, rib of a chicken, a duck, a goose, a cow, a pig or a sheep, or a leg, a wing, a foot or a segment of a chicken, a duck, a goose, a cow, a pig or a sheep, and the three-dimensional meat substitute is cooked by a barbecuing means.

38. The three-dimensional meat substitute forming method according to claim 20, wherein the three-dimensional meat substitute has appearance of a whole body of a chicken, a duck, a goose, a cow, a pig or a sheep, rib of a chicken, a duck, a goose, a cow, a pig or a sheep, or a leg, a wing, a foot or a segment of a chicken, a duck, a goose, a cow, a pig or a sheep, and the three-dimensional meat substitute is cooked by a stewing means.

39. The three-dimensional meat substitute forming method according to claim 20, wherein the three-dimensional meat substitute has appearance of a whole body or an inside egg of freshwater fish or saltwater fish.

40. The three-dimensional meat substitute forming method according to claim 20, wherein the meat substitute material is soybean, wherein in the soaking and grinding process, the soybean is soaked in water ranged between 14° C. and 25° C. for 8˜10 hours and ground into a soybean mud, wherein the soybean mud has particle fineness larger than 80 meshes.

41. The three-dimensional meat substitute forming method according to claim 40, wherein in the slurry boiling and filtering process, the soybean mud is boiled at 100° C. for 45 to 60 minutes and then dried at 105° C. for 10 minutes, so that a high-temperature soybean slurry is formed.
